(19) United States
(12) Patent Application Publication
(10) Pub. No.: US 2018/0139988 A1
(43) Pub. Date: May 24, 2018

(54) PRESERVATIVE COMPOSITION AND PRESERVATION LIQUID FOR FRUITS AND VEGETABLES, AND FRUITS AND VEGETABLES

(71) Applicant: DAINICHISEIKA COLOR & CHEMICALS MFG. CO., LTD., Tokyo (JP)

(72) Inventors: Yu ASO, Tokyo (JP); Kozaburo HAYASHI, Tokyo (JP); Takanori SANNAN, Tokyo (JP)

(21) Appl. No.: 15/568,265

(22) PCT Filed: Jun. 13, 2016
(86) PCT No.: PCT/JP2016/067483

§ 371 Date: Oct. 20, 2017

(30) Foreign Application Priority Data
Jun. 12, 2015 (JP) 2015-119398

(51) Int. Cl. A23L 3/3463; A23B 7/10; A23B 7/153; A23L 19/00; A23L 29/10

(52) U.S. Cl. CPC A23L 3/3463; A23B 7/10; A23V 2002/00; A23L 19/00; A23L 29/10; A23B 7/153

(57) ABSTRACT

There are provided: a preservative composition and a preservation liquid which can improve the shelf life of fruit and vegetables and which are safer to the human body; and fruit and vegetables treated with the preservation liquid. The present invention relates to a preservative composition for fruit and vegetables, the preservative composition containing an organic acid and/or a salt thereof, and at least one selected from the group consisting of glucosamine, glucosamine derivatives, chitin oligosaccharides, chitosan oligosaccharides, and salts thereof. Moreover, the present invention relates to a preservation liquid for fruit and vegetables, the preservation liquid containing the preservative composition and a liquid medium. Further, the present invention relates to fruit and vegetables treated with the preservation liquid.

### TECHNICAL FIELD

The present invention relates to a preservative composition for fruit and vegetables and to fruit and vegetables treated with the preservative composition.

### BACKGROUND ART

For many of fruit and vegetables, such as various kinds of fruit and vegetables, a period during which a good quality can be retained after harvesting is relatively short, and therefore various techniques on retaining the freshness and improving the shelf life of fruit and vegetables have been developed so far. The techniques on retaining the freshness and improving the shelf life of fruit and vegetables include: a keeping technique for controlling temperature, humidity, pressure, and the like; a package for storing fruit and vegetables; a freshness retaining agent for absorbing, removing, or suppressing a carbon dioxide gas and an ethylene gas produced by fruit and vegetables; a composition for improving the shelf life by addition to fruit and vegetables; and the like.

For example, in Patent Literature 1, there is proposed a coating composition for preserving perishables, the composition containing an aqueous solution of about 0.2 to about 3% by weight of chitosan or modified chitosan, about 0.1 to 1.0% by weight of an organic acid, and about 0.02 to 0.1% by weight of a surfactant.

### CITATION LIST

### Patent Literature

Patent Literature 1: National Publication of International Patent Application No. 2008-504041

### SUMMARY OF INVENTION

### Technical Problem

The composition for improving the shelf life by addition to fruit and vegetables has an advantage that an effect of improving the shelf life for a relatively long period of time inexpensively can be prospected. However, when fruit and vegetables can be preserved for a long period of time, there is a tendency that consumers, sellers, and the like of the fruit and vegetables concern over safety to the human body. Moreover, a chemical the use of which for fruit and vegetables is prohibited is different depending on the country, so that there exist chemicals the use of which is prohibited in some countries but is admitted in other countries, and such an actual situation is considered as the reason for bringing about the concern.

Accordingly, the present invention intends to provide a preservative composition and a preservation liquid which can improve the shelf life of fruit and vegetables and which is safer to the human body.

### Solution to Problem

The present inventors have inspected how long fruit and vegetables do not go rotten by using conventional preservatives used for fruit and vegetables to find that there exist some preservatives that enable the fruit and vegetables to be preserved for several months (for example, three months) as the longest period. When fruit and vegetables can be preserved for a very long period of time, a concern that a strong chemical may be used arises among consumers, sellers, and the like irrespective of whether the chemical is actually used or not. The present inventors consider that the necessity of enabling the preservation for a very long period of time, as long as several months after harvesting fruit and vegetables, is in fact not so high in preservatives for fruit and vegetables and have conducted diligent studies on active ingredients for improving the shelf life in order to further heighten the safety to the human body. As a result, the present inventors have found that the shelf life of fruit and vegetables can be improved by using an organic acid and glucosamine as components for a preservative and have completed the present invention.

That is, according to the present invention, there is provided a preservative composition for fruit and vegetables, the preservative composition containing: an organic acid and/or a salt thereof; and at least one selected from the group consisting of glucosamine, glucosamine derivatives, chitin oligosaccharides, chitosan oligosaccharides, and salts thereof. Moreover, according to the present invention, there is also provided a preservation liquid for fruit and vegetables, the preservation liquid containing the preservative composition and a liquid medium.

### Advantageous Effects of Invention

According to the present invention, a preservative composition and a preservation liquid which can improve the shelf life of fruit and vegetables and which is safer to the human body can be provided.

### DESCRIPTION OF EMBODIMENTS

Hereinafter, embodiments according to the present invention will be described; however, the present invention is not limited to the embodiments below.

### Preservative Composition

A preservative composition for fruit and vegetables according to one embodiment of the present invention (hereinafter, sometimes simply referred to as “preservative composition”) contains: an organic acid and/or a salt thereof; and at least one selected from the group consisting of glucosamine, glucosamine derivatives, chitin oligosaccharides, chitosan oligosaccharides, and salts thereof.

At least one selected from organic acids and salts thereof (hereinafter, sometimes written as “organic acids”) is a component for improving the shelf life of fruit and vegetables. When the preservative composition contains at least one selected from the group consisting of glucosamine, glucosamine derivatives, chitin oligosaccharides, chitosan oligosaccharides, and salts thereof (hereinafter, sometimes written as “glucosamine and the like”) in addition to the organic acids, the shelf life of fruit and vegetables can be further improved. The reason for this is not clear, but the present inventors consider as follows. Glucosamine and the like have a lower molecular weight than chitin and chitosan which are polymers and therefore easily penetrate in fruit and vegetables. So, it is considered that the fruit and vegetables, when detecting the penetration, produce phytoalexin, and the resisting power inherent in the fruit and vegetables themselves and the effect of improving the shelf life by the preservative composition itself are combined to improve the shelf life of the fruit and vegetables.

The preservative composition according to the present embodiment contains as active ingredients for improving the shelf life of fruit and vegetables at least one of the organic acids and at least one of glucosamine and the like and therefore can be made safer to the human body. It is to be noted that the improvements in the shelf life of fruit and vegetables in the present specification include the concept of improving a quality of keeping the fruit and vegetables good.

As the organic acids, organic acids that can be used as a food additive can be used. Examples of the organic acids include acetic acid, citric acid, lactic acid, malic acid, succinic acid, propionic acid, adipic acid, itaconic acid, gluconic acid, tartaric acid, fumaric acid, and salts thereof. Examples of suitable salts include metallic salts such as a sodium salt, a potassium salt, and a calcium salt. As the organic acids, acetic acid, citric acid, lactic acid, and salts thereof are preferable, more preferably acetic acid and salts thereof from the viewpoint of improving the shelf life of fruit and vegetables more safely. The organic acids and salts thereof can be used singly or in a combination of two or more.

Glucosamine, glucosamine derivatives, chitin oligosaccharides, chitosan oligosaccharides, and salts thereof can be obtained by subjecting chitin or chitosan to oxidative decomposition with ozone, hydrolysis with an acid or an alkali, or hydrolysis with an enzyme. Chitin is a kind of glycan contained in exoskeletons of crustaceans such as crabs and lobsters, insects, and the like, organic skeletons of squids, shellfish, and the like, and cell walls of mushrooms and mold. Chitosan is a kind of glycan obtained by subjecting chitin to deacetylation reaction caused by an alkali treatment and the like.

Examples of the salts of the glucosamine and the like include inorganic salts such as a hydrochloride, a sulfate, and a phosphate. Examples of the glucosamine derivatives include N-acetyl glucosamine and N-methyl-L-glucosamine. Among these, N-acetyl glucosamine is preferable from the viewpoint of availability, or other viewpoints. The chitin oligosaccharide is an oligosaccharide obtained through decomposition of chitin and is also called an oligo-N-acetyl glucosamine. In the present specification, the chitin oligosaccharides include slightly decomposed products of chitin. Moreover, the chitosan oligosaccharide is an oligosaccharide obtained through decomposition of chitosan and is also called an oligo glucosamine. In the present specification, the chitosan oligosaccharides include slightly decomposed products of chitosan. The chitin oligosaccharides and the chitosan oligosaccharides having a weight average molecular weight of 300 to 3000 are preferable, more preferably 300 to 2000, and still more preferably 300 to 1000. Any of the slightly decomposed products of chitin and the slightly decomposed products of chitosan has a weight average molecular weight of exceeding 3000. Glucosamine and the like can be used singly or in a combination of two or more. In the present specification, the weight average molecular weight is a value expressed in terms of pullulan measured by GPC or HPLC using pullulan as a standard substance.

Among glucosamine, glucosamine derivatives, chitin oligosaccharides, chitosan oligosaccharides, and salts thereof, glucosamine, a hydrochloride and a sulfate thereof, and N-acetyl glucosamine which are monosaccharides are preferable. Among glucosamines, glucosamine derived from a microorganism is more preferred glucosamine. The glucosamine derived from a microorganism not only has an advantage that it is further effective from the viewpoint of improving the shelf life of fruit and vegetables but also has an advantage that it does not contain an allergen originating from crustaceans such as crabs and lobsters. The glucosamine derived from a microorganism can be obtained by a method in which a genetically modified microorganism of an Escherichia coli, a yeast, or the like is used to produce glucosamine by fermentation, or by a method in which a filamentous fungus having ability of producing glucosamine is used and cultured in a liquid to produce glucosamine in the culture medium by fermentation, and the glucosamine is then separated efficiently. Glucosamine derived from a microorganism is more preferably glucosamine derived from a microorganism used for citric acid fermentation. This glucosamine can be obtained by decomposing/purifying a chitinous substance contained in a microorganism fungus body such as a filamentous fungus used in citric acid fermentation, and especially contained in a cell wall of the microorganism fungus body (see, for example, National Publication of International Patent Application No. 2005-507233). Examples of the suitable microorganism fungus body (eumycete) include filamentous fungi of the Aspergillus species, the Penicillium species, the Mucor species, and the like. Examples of more preferred eumycete include microorganism fungus bodies belonging to the Aspergillus species such as Aspergillus niger (black koji mold), Aspergillus terreus, and Aspergillus oryzae. As a culture medium used for fermentation of these microorganism fungus bodies, a medium containing sugar such as starch is suitable, and a medium containing sugar from a plant, such as corn starch, is more suitable.

Among the above-described slightly decomposed products of chitosan, chitosan derived from a fruiting body, a mycelium, or the like of a shiitake mushroom, an enoki mushroom, a mushroom, a maitake mushroom, an eryngii mushroom, a shimeji (brown beech) mushroom, or the like which is a basidiomycete, and chitosan derived from a mycelium of a eumycete or a cell wall of a yeast (hereinafter, sometimes written as “chitosan derived from a cell wall”) are also preferable. The chitosan derived from a cell wall can be obtained in such a way that chitin extracted from a mycelium of a eumycete or a cell wall of a yeast is brought into contact with an alkaline solution to obtain an alkali-insoluble fraction, the alkali-insoluble fraction is then suspended, and the suspended fraction is brought into contact with an acidic solution. As the alkaline solution, an aqueous solution of an alkali such as, for example, sodium hydroxide, potassium hydroxide, lithium hydroxide, and ammonium hydroxide can be used. As the acidic solution, an aqueous solution of an acid such as, for example, hydrochloric acid, acetic acid, and formic acid can be used. The above-described cell wall is more preferably a cell wall from Aspergillus niger and is still more preferably a cell wall from a byproduct of culture process in which a cultured product of Aspergillus niger is used for obtaining citric acid. Such chitosan derived from a cell wall is, as described above, a decomposed product of chitin extracted from a cell wall, has a lower molecular weight than general chitosan derived from a crustacean, and therefore is described as one example of the slightly decomposed products of chitosan. It is preferable that the chitosan derived from a cell wall have a weight average molecular weight of 100000 or lower, more preferably 50000 or lower, and still more preferably 30000 or lower. It is to be noted that the method for preparing the chitosan derived from a cell wall is disclosed as a method by which low-molecular weight chitosan can be prepared in National Publication of International Patent Application No. 2005-529191.

The present inventors infer as follows the reason that the chitosan derived from a cell wall (more preferably chitosan derived from a cell wall of Aspergillus oryzae) can exhibit the effect of improving the shelf life of fruit and vegetables by using it with the organic acid, which is different from the case where the chitosan derived from a crustacean is used. Both in the case of chitosan derived from a crustacean and in the case of chitosan derived from a cell wall, it is chitin that exists in the living body, and the chitin is deacetylated to make chitosan. Chitin existing in the crustaceans and chitin existing in the cell walls of eumycetes or the like are different in the steric structure and the crystallinity, and there is a possibility that various kinds of chitosan having a different steric structure and a different degree of crystallinity are obtained. Moreover, there is a good likelihood that the differences in the steric structure and the degree of crystallinity induce a difference in sites where deacetylation reaction occurs to make distributions of the resultant amino groups and acetamide groups derived from chitin different. It is inferred that these are each one of factors that chitosan derived from a crustacean and chitosan derived from a cell wall exhibit a different effect on fruit and vegetables.

Glucosamine and the like may be commercially available products. Examples of commercially available glucosamine include trade name “NATURAL GLUCOSAMINE G” (Yaizu Suisankagaku Industry Co., Ltd.) and trade name “KOYO GLUCOSAMINE” (manufactured by KOYO CHEMICAL CO., LTD.). Examples of commercially available glucosamine derived from a microorganism include trade names “Fermented Glucosamine G” and “Fermented Glucosamine K)” (each manufactured by KYOWA HAKKO BIO CO., LTD.). Examples of commercially available N-acetyl glucosamine include trade name “MARINE SWEET YSK” (manufactured by Yaizu Suisankagaku Industry Co. , Ltd.) and trade name “KOYO N-ACETYL GLUCOSAMINE PG” (manufactured by KOYO CHEMICAL CO., LTD.). Examples of the commercially available chitin oligosaccharide include trade name “NA-COS-Y” (manufactured by Yaizu Suisankagaku Industry Co., Ltd.) and trade name “OLIGO-N-ACETYL GLUCOSAMINE” (manufactured by KOYO CHEMICAL CO., LTD.). Examples of the commercially available chitosan oligosaccharide include trade name “COS-YS” (manufactured by Yaizu Suisankagaku Industry Co., Ltd.). Examples of commercially available chitosan derived from a cell wall include trade names “KiOmedine-CsU”, “KiOnutrime-CsG”, and “KitoGreen” (all manufactured by KitoZyme).

It is preferable that the preservative composition further contain an emulsifying agent (surfactant). When the emulsifying agent is contained in the preservative composition, respective components contained in the preservative composition can be miscible with each other easily. As the emulsifying agent, emulsifying agents that can be used for food as a food additive can be used. Examples of the emulsifying agent include glycerin fatty acid esters, sucrose fatty acid esters, sorbitan fatty acid esters, propylene glycol fatty acid esters, polyoxyethylene sorbitan fatty acid esters (polysorbates), nonionic emulsifying agents such as lecithin, and anionic emulsifying agents such as acylated lactic acid. The nonionic emulsifying agents are preferable because they give low irritation and give less influences on the environment, and from other reasons. Among the nonionic emulsifying agents, glycerin fatty acid esters, sucrose fatty acid esters, sorbitan fatty acid esters, and polyoxyethylene sorbitan fatty acid esters (polysorbates) are more preferred nonionic emulsifying agents from the viewpoint of making the miscibility of respective components in the preservative composition good. The emulsifying agent can be used singly or in a combination of two or more.

It is preferable that the preservative composition contain water, which will be described later, and therefore it is preferable that the emulsifying agent be miscible well with or dissolve in water. From this viewpoint, it is preferable that the emulsifying agent have an HLB of 8 or more, more preferably 10 or more, and still more preferably 12 or more. The numerical value of the HLB can be determined by a Griffin method, and the upper limit value of HLB is 20.

Examples of the glycerin fatty acid esters include monoglycerin fatty acid esters, monoglycerin fatty acid organic acid esters, and polyglycerin fatty acid esters. Specific examples of the monoglycerin fatty acid esters include a monoglycerin monocaprylic acid ester, a monoglycerin dicaprylic acid ester, a monoglycerin monocapric acid ester, a monoglycerin dilauric acid ester, a monoglycerin dimyristic acid ester, a monoglycerin distearic acid ester, a monoglycerin dioleic acid ester, a monoglycerin dierucic acid ester, and a monoglycerin dibehenic acid ester. Specific examples of the monoglycerin fatty acid organic acid esters include a monoglycerin caprylic acid succinic acid ester, a monoglycerin stearic acid citric acid ester, a monoglycerin stearic acid acetic acid ester, a monoglycerin stearic acid succinic acid ester, a monoglycerin stearic acid lactic acid ester, a monoglycerin stearic acid diacetyl tartaric acid ester, and a monoglycerin oleic acid citric acid ester. Examples of the polyglycerin fatty acid esters include esters of polyglycerin having an average degree of polymerization of 2 or more (preferably 6 to 15) and a fatty acid having 8 to 18 carbon atoms (for example, caprylic acid, capric acid, lauric acid, myristic acid, palmitic acid, stearic acid, oleic acid, and linoleic acid).

Examples of the sucrose fatty acid esters include esterified products obtained by esterifying each of at least one hydroxy group contained in sucrose with a fatty acid having 6 to 22 carbon atoms. Specific examples of the sucrose fatty acid esters include a sucrose palmitic acid ester, a sucrose stearic acid ester, a sucrose lauric acid ester, a sucrose behenic acid ester, and a sucrose erucic acid ester.

Examples of the sorbitan fatty acid esters include esterified products obtained by esterifying each of at least one hydroxy group contained in sorbitan with a fatty acid having 6 to 18 carbon atoms. Specific examples of the sorbitan fatty acid esters include a sorbitan monocaprylic acid ester, a sorbitan monolauric acid ester, a sorbitan monostearic acid ester, and a sorbitan monooleic acid ester.

As the polyoxyethylene sorbitan fatty acid esters (polysorbates), polyoxyethylene sorbitan fatty acid esters (polysorbates) in which the fatty acid has 8 to 22 carbon atoms are preferable, more preferably polyoxyethylene sorbitan fatty acid esters (polysorbates) each having a number of moles of added ethylene oxides of 2 to 100 in the polyoxyethylene moiety. Specific examples of the polyoxyethylene sorbitan fatty acid esters include polyoxyethylene sorbitan monostearate, polyoxyethylene sorbitan monooleate, polyoxyethylene sorbitan tristearate, and polyoxyethylene sorbitan trioleate.

It is preferable that the preservative composition further contain a spreading agent. The spreading agent is a component for bringing out luster by adhering to the surface of fruit and vegetables for which the preservative composition is used. When the spreading agent is contained in the preservative composition, both the effect of treatment for improving the shelf life of fruit and vegetables with the preservative composition and the effect of bringing out luster can be obtained, which makes it possible to omit working of conducting a coating treatment separately.

Also, the spreading agents that are usable as a food additive can be used. Examples of the spreading agent include cellulose, cellulose derivatives, polyvinylpyrrolidone, polyvinyl alcohol, sodium polyacrylate, starch, starch phosphates, pectin, gelatin, mannan, and agar. Among these spreading agents, cellulose and cellulose derivatives are preferable, more preferably cellulose derivatives such as methyl cellulose, hydroxypropyl cellulose, hydroxypropyl methyl cellulose, calcium carboxymethyl cellulose, and sodium carboxymethyl cellulose. The spreading agents can be used singly or in a combination of two or more.

It is preferable that the preservative composition contain propylene glycol as a quality retaining agent in order to retain the quality of fruit and vegetables or improve the quality of keeping fruit and vegetables good. When the quality retaining agent is used together with the at least one of the organic acids described previously and the at least one of glucosamine and the like described previously, the effect of improving the shelf life of fruit and vegetables can be enhanced further.

In addition to the respective components described previously, food additives that have been used conventionally, such as, for example, a food preservative, a sterilizing/bleaching agent, and an anti-mold agent as described below may be contained in the preservative composition within a range where the object of the present invention is not impaired. For example, the preservative composition may contain the food preservative such as benzoic acids (benzoic acid and sodium benzoate), sorbic acids (sorbic acid, and potassium salt and sodium salt thereof), para-hydroxybenzoic acid esters (methyl para-hydroxybenzoate, ethyl para-hydroxybenzoate, propyl para-hydroxybenzoate, isopropyl para-hydroxybenzoate, butyl para-hydroxybenzoate, isobutyl para-hydroxybenzoate), propionic acids (propionic acid, and calcium salt and sodium salt thereof), and polylysine. Moreover, the preservative composition may contain the sterilizing/bleaching agent such as hydrogen peroxide, sodium chlorite, hydrochlorous acid water, sodium hypochlorite, sodium sulfite, potassium pyrosulfite, sodium pyrosulfite, and sodium hyposulfite. Further, the preservative composition may contain the anti-mold agent such as imazalil, ortho-phenylphenol and a sodium salt thereof, thiabendazole, and fludioxonil.

However, the preservative composition according to the present embodiment, which contains, as described previously, at least one of the organic acids and at least one of glucosamine and the like, is intended to utilize the resisting power inherent in fruit and vegetables themselves as well as the effect of improving the shelf life by the preservative composition itself. Therefore, the shelf life of fruit and vegetables can be improved without using the food preservative, the sterilizing/bleaching agent, and the anti-mold agent described previously. Accordingly, the preservative composition that is further safe to the human body can be provided. From this viewpoint, it is preferable that the preservative composition be substantially free of the previously described compounds listed as the food preservative, the sterilizing/bleaching agent, and the anti-mold agent. Being substantially free of the food preservative, the sterilizing/bleaching agent, and the anti-mold agent means that the food preservative, the sterilizing/bleaching agent, and the anti-mold agent are not contained in an amount to such an extent that an effect as an application of a food preservative, a sterilizing/bleaching agent, or an anti-mold agent is exhibited by each content per se.

The preservative composition according to the present embodiment can take any form of, for example, a liquid form, a powder form, a paste form, a gel form, and a tablet form following a usual method. Respective components, such as organic acids, and glucosamine and the like, contained in the preservative composition may be integrated into a single agent or may be used separately as a set (kit).

Among the above-described forms, it is preferable that the preservative composition be in a liquid form, a paste form, or a gel form, more preferably be in a liquid form. In the case of the liquid form, the preservative composition further preferably contains a liquid medium. When the preservative composition is in the liquid form or the like, and further contains the liquid medium, a preservation liquid in which the preservative composition is further diluted with another liquid medium (liquid medium for dilution) can be obtained easily. As a result, fruit and vegetables can be treated easily with the preservation liquid by a method such as a spraying, applying, or an immersing method. It is preferable to use water, an alcohol (suitably ethanol), or a mixture thereof as the liquid medium from the viewpoint of safety to the human body and other viewpoints.

It is preferable that the preservative composition in any form be a preservative composition (preservative composition for preparing preservation liquid) to be used as a high-concentration preservative composition, in which the concentrations of respective components are increased, by being diluted with the liquid medium such as water at the time of use from the viewpoint of good usability. It is preferable that the contents of respective components described previously be in the ranges as described in the following so that the preservative composition can be diluted and used and the effects by the respective components can be obtained in the preservation liquid in which the preservative composition is diluted.

It is preferable that the content of glucosamine and the like described previously be 0.1 to 20% by mass, more preferably 0.2 to 15% by mass, and still more preferably 0.5 to 15% by mass in the total mass of the preservative composition.

It is preferable that the content of the organic acids described previously be 1 to 50% by mass, more preferably 2 to 40% by mass, and still more preferably 5 to 30% by mass in the total mass of the preservative composition.

It is preferable that the content of the emulsifying agent described previously be 0.1 to 5% by mass, more preferably 0.2 to 4% by mass in the total mass of the preservative composition.

It is preferable that the content of the spreading agent described previously be 1 to 20% by mass, more preferably 2 to 10% by mass in the total mass of the preservative composition.

It is preferable that the content of the quality retaining agent (propylene glycol) described previously be 1 to 30% by mass, more preferably 5 to 20% by mass in the total mass of the preservative composition.

It is preferable that the content of the liquid medium described previously be 40 to 95% by mass, more preferably 40 to 80% by mass, and still more preferably 40 to 75% by mass in the total mass of the preservative composition.

It is to be noted that when two or more components of the same type are contained in the preservative composition, the content of each component means the total content of the two or more components of the same type.

As described above, it is preferable that the preservative composition be prepared in a liquid form and used as the preservation liquid so as to treat fruit and vegetables easily at the time of use. For example, in the case where the preservative composition is in the liquid form or a semisolid form, such as the paste form or the gel form, in which high concentrations of respective components are contained, the preservative composition can be diluted with the liquid medium and used as the preservation liquid. Moreover, in the case where the preservative composition is, for example, in a solid form, such as a powder form and a tablet form, the preservative composition can be used as the preservation liquid in which the preservative composition is dissolved with the liquid medium (solvent) or the preservation liquid in a form of a dispersion liquid in which the preservative composition is dispersed with the liquid medium (dispersion medium).

### Preservation Liquid

The preservation liquid for fruit and vegetables according to one embodiment of the present invention contains: the preservative composition described previously; and the liquid medium. The preservative composition can contain, as described previously, the liquid medium, and moreover may be in a liquid form, and therefore the preservation liquid maybe the preservative composition in a liquid form or may be a diluted preservative composition in which the preservative composition is diluted with the liquid medium such as water at the time of use. In the present specification, the preservative composition which contains as essential components the liquid medium, at least one of the organic acids, and at least one of glucosamine and the like, and which is in a liquid form that is usable as it is for fruit and vegetables is referred to as the preservation liquid for convenience. Accordingly, the preservation liquid can be produced by preparing the preservative composition and then diluting the preservative composition with the liquid medium, and can also be produced not through the work of dilution.

The preservation liquid according to the present embodiment contains: the organic acid and/or the salt thereof; at least one selected from the group consisting of glucosamine, glucosamine derivatives, chitin oligosaccharides, chitosan oligosaccharides, and salts thereof; and the liquid medium. These components are each the same as listed in the description of the preservative composition.

It is preferable that the content of the organic acid and/or the salt thereof be 0.1 to 10% by mass, more preferably 0.2 to 9% by mass, and still more preferably 0.3 to 8% by mass in the total mass of the preservation liquid. It is preferable that the content of the organic acid and/or the salt thereof be 0.1% by mass or more, more preferably 0.5% by mass or more, and still more preferably 1% by mass or more from the viewpoint of improving the shelf life of fruit and vegetables. Moreover, it is preferable that the content of the organic acid and/or the salt thereof be 10% by mass or less, more preferably 8% by mass or less, and still more preferably 5% by mass or less in the total mass of the preservation liquid from the viewpoint of the safety to the human body and the flavor of fruit and vegetables when the preservation liquid is used for fruit and vegetables as food. It is to be noted that when the preservation liquid contains two or more kinds of the organic acids and/or the salts thereof, the content of the organic acid and/or the salt thereof means the total content of the two or more kinds of the organic acids and/or the salts thereof.

It is preferable that the content of the at least one selected from the group consisting of glucosamine, glucosamine derivatives, chitin oligosaccharides, chitosan oligosaccharides, and salts thereof be 0.01 to 5% by mass in the total mass of the preservation liquid. It is preferable that the content of glucosamine and the like be 0.01% by mass or more, more preferably 0.02% by mass or more, and still more preferably 0.05% by mass or more from the viewpoint of improving the shelf life of fruit and vegetables. It is preferable that the content of glucosamine and the like be 5% by mass or less, more preferably 3% by mass or less, and still more preferably 1.5% by mass or less so that glucosamine and the like are easily miscible in the preservation liquid and because the content of glucosamine and the like being too large leads to an increase in the production cost. It is to be noted that when the preservation liquid contains two or more kinds of glucosamine and the like, the content of glucosamine and the like means the total content of the two or more kinds of glucosamine and the like.

It is preferable that the emulsifying agent listed in the description of the preservative composition be contained in the preservation liquid so that glucosamine and the like are easily miscible with the liquid medium such as water. The content of the emulsifying agent is not particularly limited and can be, for example, about 0.01 to about 1% by mass in the total mass of the preservation liquid so that glucosamine and the like are easily miscible with the liquid medium such as water. It is to be noted that when the preservation liquid contains two or more kinds of emulsifying agents, the content of the emulsifying agent means the total content of the two or more kinds of emulsifying agents.

The content of the liquid medium is not particularly limited and can be the balance by which the total content of respective components including the liquid medium in the preservation liquid reaches 100% by mass. For example, the content of the liquid medium can be 90 to 99.5% by mass in the total mass of the preservation liquid. It is to be noted that when the preservation liquid contains two or more kinds of liquid media, the content of the liquid medium means the total content of the two or more kinds of liquid media.

It is preferable that the spreading agent listed in the description of the preservative composition be contained in the preservation liquid so that the effect of bringing out the luster to fruit and vegetables treated with the preservation liquid can be obtained. It is preferable that the content of the spreading agent be 0.1 to 5% by mass, more preferably 0.2 to 5% by mass, and still more preferably 0.5 to 5% by mass in the total mass of the preservation liquid so that the effect of bringing out the luster due to the spreading agent can be obtained. It is to be noted that when the preservation liquid contains two or more kinds of spreading agents, the content of the spreading agent means the total content of the two or more kinds of spreading agents.

It is preferable that the quality retaining agent (propylene glycol) listed in the description of the preservative composition be contained in the preservation liquid in order to retain the quality of fruit and vegetables or improve the quality of keeping fruit and vegetables good. It is preferable that content of the quality retaining agent (propylene glycol) be 0.1 to 5% by mass, more preferably 0.5 to 5% by mass, and still more preferably 1 to 5% by mass in the total mass of the preservation liquid.

The usage of the preservation liquid according to the present embodiment is not particularly limited, and the preservation liquid can be used by bringing the preservation liquid into contact with fruit and vegetables which are the objects of treatment. The method of bringing the preservation liquid into contact with fruit and vegetables can be selected appropriately according to the fruit and vegetables. Examples thereof include a method of immersing fruit and vegetables in the preservation liquid and a method of applying or spraying the preservation liquid on fruit and vegetables. As one example of preferable methods, a method is given in which the preservation liquid is sprayed on fruit and vegetables with the exocarps or hulls after harvesting. By taking the method by means of spraying, it becomes easy to cover almost the whole outer surface of fruit and vegetables with the preservation liquid, thereby making it easier to obtain the effect of improving the shelf life of the fruit and vegetables.

The amount of the preservation liquid used to fruit and vegetables is not particularly limited and can be determined appropriately according to the kind and the like of fruit and vegetables to be the objects of treatment. For example, the preservation liquid can be used in an amount to such an extent the preservation liquid is applied uniformly on the whole fruit and vegetables and dropping of liquid does not occur. It is preferable that the amount of the preservation liquid to be used be 0.05 mg/cm² or more, more preferably 0.1 mg/cm² or more, and still more preferably 0.2 mg/cm² or more expressed by the dry mass of the preservation liquid per unit surface area of fruit and vegetables from the viewpoint of improving the shelf life of fruit and vegetables. Moreover, it is preferable that the amount of the preservation liquid to be used be 10 mg/cm² or less, more preferably 5 mg/cm² or less, and still more preferably 2 mg/cm² or less from the viewpoint of the safety to the human body. It is to be noted that the above-described amount of the preservation liquid to be used is one example and can be adjusted appropriately according to the kind, size, mass, and the like of fruit and vegetables which are the objects of treatment.

The preservative composition and the preservation liquid according to the present embodiment are used for preservation of fruit and vegetables and suitably for preservation of various kinds of fruit (various kinds of edible fruit) and vegetables. Moreover, the preservative composition and the preservation liquid can be used both before and after harvesting fruit and vegetables. More preferably, the preservative composition and the preservation liquid are used for fresh fruit or fresh vegetables after harvesting over the period between the time when the fruit and vegetables are harvested and the time when the fruit and vegetables are bought by consumers, and further preferably the preservative composition and the preservation liquid are used for fruit or vegetables with the exocarps or hulls after harvesting. Specific example of the suitable fruit and vegetables to be an object for which the preservative composition and the preservation liquid are used include an apple, a Japanese pear, grape, a banana, a mango, a melon, an orange, a mandarin orange, a lemon, a lime, a pineapple, a papaya, an avocado, and a tomato.

The preservative composition and the preservation liquid according to the present embodiment, which have been described in detail above, each contain as active ingredients at least one of the organic acids and at least one of glucosamine and the like. Therefore, when the preservative composition or the preservation liquid is used, the shelf life of fruit and vegetables can be improved while the safety to the human body is secured. When fruit and vegetables are treated with the preservation liquid, the quality of keeping fruit and vegetables good can be improved about several weeks longer than in the case where the fruit and vegetables are not treated at all.

By using the preservation liquid according to the present embodiment, fruit and vegetables treated with the preservation liquid can be obtained. The fruit and vegetables, when treated with the preservation liquid, can be made so that the components in the preservation liquid are adhered to the fruit and vegetables. The fruit and vegetables treated with the preservation liquid are kept good longer than fruit and vegetables not treated with the preservation liquid, and fruit and vegetables to which rot and partial discoloration accompanying the rot are hard to occur over about several weeks (for example, about 1 to about 8 weeks) after the fruit and vegetables are harvested can be obtained.

It is to be noted that the preservative composition, the preservation liquid, and the fruit and vegetables according to one embodiment of the present invention, which have been described above, can take the following constitution.

[1] A preservative composition for fruit and vegetables, the preservative composition containing: an organic acid and/or a salt thereof; and at least one selected from the group consisting of glucosamine, glucosamine derivatives, chitin oligosaccharides, chitosan oligosaccharides, and salts thereof.

[2] The preservative composition according to [1], containing glucosamine derived from a microorganism as the glucosamine.

[3] The preservative composition according to [1] or [2], wherein the organic acid and/or the salt thereof is at least one selected from the group consisting of acetic acid, citric acid, lactic acid, and salts thereof.

[4] The preservative composition according to anyone of [1] to [3], further containing an emulsifying agent.

[5] The preservative composition according to anyone of [1] to [4], further containing a spreading agent.

[6] The preservative composition according to anyone of [1] to [5], wherein a content of the at least one selected from the group consisting of glucosamine, glucosamine derivatives, chitin oligosaccharides, chitosan oligosaccharides, and salts thereof is 0.1 to 20% by mass.

[7] The preservative composition according to anyone of [1] to [6], wherein a content of the organic acid and/or the salt thereof is 1 to 50% by mass.

[8] A preservation liquid for fruit and vegetables, the preservation liquid containing: an organic acid and/or a salt thereof; at least one selected from the group consisting of glucosamine, glucosamine derivatives, chitin oligosaccharides, chitosan oligosaccharides, and salts thereof; and a liquid medium.

[9] The preservation liquid for fruit and vegetables according to [8], wherein a content of the at least one selected from the group consisting of glucosamine, glucosamine derivatives, chitin oligosaccharides, chitosan oligosaccharides, and salts thereof is 0.01 to 5% by mass.

[10] The preservation liquid according to [8] or [9], wherein a content of the organic acid and/or the salt thereof is 0.1 to 10% by mass.

[11] Fruit and vegetables treated with the preservation liquid according to any of [8] to [10].

### EXAMPLES

Hereinafter, the present invention will be described specifically based on Examples; however, the present invention is not limited to Examples below. It is to be noted that “part (s) ” and “%” in Examples below are each on a mass basis unless otherwise stated.

### Preparation of Preservative Composition

### Example 1

Acetic acid: 20% and glucosamine derived from a microorganism (trade name “Fermented Glucosamine K”, manufactured by KYOWA HAKKO BIO CO., LTD.): 1% were mixed and dissolved in water to prepare a preservative composition (stock solution) 1. The amount of water used was the balance by which the total content of respective components including water reached 100%. The amount of water used (content of water) is the same in Examples and Comparative Examples below.

### Example 2

Citric acid: 20% and glucosamine derived from a microorganism (trade name “Fermented Glucosamine K”, manufactured by KYOWA HAKKO BIO CO., LTD.): 2% were mixed and dissolved in water to prepare a preservative composition (stock solution) 2.

### Example 3

Lactic acid: 20% and glucosamine derived from a microorganism (trade name “Fermented Glucosamine K”, manufactured by KYOWA HAKKO BIO CO., LTD.): 2% were mixed and dissolved in water to prepare a preservative composition (stock solution) 3.

### Example 4

Acetic acid: 20% and N-acetyl glucosamine (trade name “KOYO N-ACETYL GLUCOSAMINE PG”, manufactured by KOYO CHEMICAL CO., LTD.): 1% were mixed and dissolved in water to prepare a preservative composition (stock solution) 4.

### Example 5

Acetic acid: 20% and a chitin oligosaccharide (trade name “OLIGO-N-ACETYL GLUCOSAMINE”, manufactured by KOYO CHEMICAL CO., LTD.): 1% were mixed and dissolved in water to prepare a preservative composition (stock solution) 5.

### Example 6

Acetic acid: 20% and a chitosan oligosaccharide (trade name “COS-YS”, manufactured by Yaizu Suisankagaku Industry Co., Ltd.): 1% were mixed and dissolved in water to prepare a preservative composition (stock solution) 6.

### Example 7

Acetic acid: 20% and chitosan derived from a cell wall of a mushroom (trade name “Kiomedine-CsU”, manufactured by KitoZyme, weight average molecular weight of 30000): 1% were mixed and dissolved in water to prepare a preservative composition (stock solution) 7.

### Example 8

Acetic acid: 20%, glucosamine derived from a microorganism (trade name “Fermented Glucosamine K”, manufactured by KYOWA HAKKO BIO CO., LTD.): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 8.

### Example 9

Acetic acid: 20%, glucosamine derived from a microorganism (trade name “Fermented Glucosamine K”, manufactured by KYOWA HAKKO BIO CO., LTD.): 1%, an emulsifying agent (polyoxyethylene sorbitan monooleate, trade name “WILSURF TF-80”, manufactured by NOF CORPORATION): 1.7%, and hydroxypropyl cellulose: 7% were mixed and dissolved in water to prepare a preservative composition (stock solution) 9.

### Example 10

Acetic acid: 20%, glucosamine derived from a microorganism (trade name “Fermented Glucosamine K”, manufactured by KYOWA HAKKO BIO CO., LTD.): 1%, an emulsifying agent (polyoxyethylene sorbitan monooleate, trade name “WILSURF TF-80”, manufactured by NOF CORPORATION): 1.7%, and propylene glycol: 12% were mixed and dissolved in water to prepare a preservative composition (stock solution) 10.

### Example 11

Acetic acid: 20%, glucosamine derived from a microorganism (trade name “Fermented Glucosamine K”, manufactured by KYOWA HAKKO BIO CO., LTD.): 1%, an emulsifying agent (polyoxyethylene sorbitan monooleate, trade name “WILSURF TF-80”, manufactured by NOF CORPORATION): 1.7%, hydroxypropyl cellulose: 7%, and propylene glycol: 12% were mixed and dissolved in water to prepare a preservative composition (stock solution) 11.

### Example 12

Citric acid: 20%, glucosamine derived from a microorganism (trade name “Fermented Glucosamine K”, manufactured by KYOWA HAKKO BIO CO., LTD.): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 12.

### Example 13

Lactic acid: 20%, glucosamine derived from a microorganism (trade name “Fermented Glucosamine K”, manufactured by KYOWA HAKKO BIO CO., LTD.): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 13.

### Example 14

Acetic acid: 20%, N-acetyl glucosamine (trade name “KOYO N-ACETYL GLUCOSAMINE PG”, manufactured by KOYO CHEMICAL CO., LTD.): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 14.

### Example 15

Acetic acid: 20%, a chitin oligosaccharide (trade name “OLIGO-N-ACETYL GLUCOSAMINE”, manufactured by KOYO CHEMICAL CO., LTD.): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 15.

### Example 16

Acetic acid: 20%, a chitosan oligosaccharide (trade name “COS-YS”, manufactured by Yaizu Suisankagaku Industry Co., Ltd.): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 16.

### Example 17

Acetic acid: 20%, chitosan derived from a cell wall of a mushroom (trade name “Kiomedine-CsU”, manufactured by KitoZyme, weight average molecular weight of 30000): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 17.

### Example 18

Acetic acid: 5%, glucosamine derived from a microorganism (trade name “Fermented Glucosamine K”, manufactured by KYOWA HAKKO BIO CO., LTD.): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 18.

### Example 19

Acetic acid: 30%, glucosamine derived from a microorganism (trade name “Fermented Glucosamine K”, manufactured by KYOWA HAKKO BIO CO., LTD.): 1%, an emulsifying agent (polyoxyethylene sorbitan monooleate, trade name “WILSURF TF-80”, manufactured by NOF CORPORATION): 1.7%, and hydroxypropyl cellulose: 7% were mixed and dissolved in water to prepare a preservative composition (stock solution) 19.

### Example 20

Acetic acid: 20%, glucosamine derived from a microorganism (trade name “Fermented Glucosamine K”, manufactured by KYOWA HAKKO BIO CO., LTD.): 0.1%, an emulsifying agent (polyoxyethylene sorbitan monooleate, trade name “WILSURF TF-80”, manufactured by NOF CORPORATION): 1.7%, and propylene glycol: 12% were mixed and dissolved in water to prepare a preservative composition (stock solution) 20.

### Example 21

Acetic acid: 20%, glucosamine derived from a microorganism (trade name “Fermented Glucosamine K”, manufactured by KYOWA HAKKO BIO CO., LTD.): 15%, an emulsifying agent (polyoxyethylene sorbitan monooleate, trade name “WILSURF TF-80”, manufactured by NOF CORPORATION): 1.7%, hydroxypropyl cellulose: 7%, and propylene glycol: 12% were mixed and dissolved in water to prepare a preservative composition (stock solution) 21.

### Example 22

Citric acid: 5%, glucosamine derived from a microorganism (trade name “Fermented Glucosamine K”, manufactured by KYOWA HAKKO BIO CO., LTD.): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 22.

### Example 23

Citric acid: 30%, glucosamine derived from a microorganism (trade name “Fermented Glucosamine K”, manufactured by KYOWA HAKKO BIO CO., LTD.): 1%, an emulsifying agent (polyoxyethylene sorbitan monooleate, trade name “WILSURF TF-80”, manufactured by NOF CORPORATION): 1.7%, and hydroxypropyl cellulose: 7% were mixed and dissolved in water to prepare a preservative composition (stock solution) 23.

### Example 24

Citric acid: 20%, glucosamine derived from a microorganism (trade name “Fermented Glucosamine K”, manufactured by KYOWA HAKKO BIO CO., LTD.): 0.1%, an emulsifying agent (polyoxyethylene sorbitan monooleate, trade name “WILSURF TF-80”, manufactured by NOF CORPORATION): 1.7%, and propylene glycol: 12% were mixed and dissolved in water to prepare a preservative composition (stock solution) 24.

### Example 25

Citric acid: 20%, glucosamine derived from a microorganism (trade name “Fermented Glucosamine K”, manufactured by KYOWA HAKKO BIO CO., LTD.): 15%, an emulsifying agent (polyoxyethylene sorbitan monooleate, trade name “WILSURF TF-80”, manufactured by NOF CORPORATION): 1.7%, hydroxypropyl cellulose: 7%, and propylene glycol: 12% were mixed and dissolved in water to prepare a preservative composition (stock solution) 25.

### Example 26

Lactic acid: 5%, glucosamine derived from a microorganism (trade name “Fermented Glucosamine K”, manufactured by KYOWA HAKKO BIO CO., LTD.): 1%, and an emulsifying agent (polyoxyethylene sorbitan monooleate, trade name “WILSURF TF-80”, manufactured by NOF CORPORATION): 1.7% were mixed and dissolved in water to prepare a preservative composition (stock solution) 26.

### Example 27

Lactic acid: 30%, glucosamine derived from a microorganism (trade name “Fermented Glucosamine K”, manufactured by KYOWA HAKKO BIO CO., LTD.): 1%, an emulsifying agent (polyoxyethylene sorbitan monooleate, trade name “WILSURF TF-80”, manufactured by NOF CORPORATION): 1.7%, and hydroxypropyl cellulose: 7% were mixed and dissolved in water to prepare a preservative composition (stock solution) 27.

### Example 28

Lactic acid: 20%, glucosamine derived from a microorganism (trade name “Fermented Glucosamine K”, manufactured by KYOWA HAKKO BIO CO., LTD.): 0.1%, an emulsifying agent (polyoxyethylene sorbitan monooleate, trade name “WILSURF TF-80”, manufactured by NOF CORPORATION): 1.7%, and propylene glycol: 12% were mixed and dissolved in water to prepare a preservative composition (stock solution) 28.

### Example 29

Lactic acid: 20%, glucosamine derived from a microorganism (trade name “Fermented Glucosamine K”, manufactured by KYOWA HAKKO BIO CO., LTD.): 15%, an emulsifying agent (polyoxyethylene sorbitan monooleate, trade name “WILSURF TF-80”, manufactured by NOF CORPORATION): 1.7%, hydroxypropyl cellulose: 7%, and propylene glycol: 12% were mixed and dissolved in water to prepare a preservative composition (stock solution) 29.

### Comparative Example 1

Acetic acid: 20% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 1.

### Comparative Example 2

Glucosamine derived from a microorganism (trade name “Fermented Glucosamine K”, manufactured by KYOWA HAKKO BIO CO., LTD.): 1% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 2.

### Comparative Example 3

Acetic acid: 5% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 3.

### Comparative Example 4

Acetic acid: 30% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 4.

### Comparative Example 5

Glucosamine derived from a microorganism (trade name “Fermented Glucosamine K”, manufactured by KYOWA HAKKO BIO CO., LTD.): 0.1% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 5.

### Comparative Example 6

Glucosamine derived from a microorganism (trade name “Fermented Glucosamine K”, manufactured by KYOWA HAKKO BIO CO., LTD.): 25% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 6.

### Comparative Example 7

Citric acid: 5% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 7.

### Comparative Example 8

Citric acid: 30% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 8.

### Comparative Example 9

Lactic acid: 5% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 9.

### Comparative Example 10

Lactic acid: 30% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 10.

### Comparative Example 11

N-acetyl glucosamine (trade name “KOYO N-ACETYL GLUCOSAMINE”, manufactured by KOYO CHEMICAL CO., LTD.): 0.1% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 11.

### Comparative Example 12

N-acetyl glucosamine (trade name “KOYO N-ACETYL GLUCOSAMINE”, manufactured by KOYO CHEMICAL CO., LTD.): 5% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 12.

### Comparative Example 13

A chitin oligosaccharide (trade name “OLIGO-N-ACETYL GLUCOSAMINE”, manufactured by KOYO CHEMICAL CO., LTD.): 0.1% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 13.

### Comparative Example 14

A chitin oligosaccharide (trade name “OLIGO-N-ACETYL GLUCOSAMINE”, manufactured by KOYO CHEMICAL CO., LTD.): 1% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 14.

### Comparative Example 15

A chitosan oligosaccharide (trade name “COS-YS”, manufactured by Yaizu Suisankagaku Industry Co., Ltd.): 0.1% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 15.

### Comparative Example 16

A chitosan oligosaccharide (trade name “COS-YS”, manufactured by Yaizu Suisankagaku Industry Co., Ltd.): 25% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 16.

### Comparative Example 17

Chitosan derived from a crustacean (trade name “SSA190”, manufactured by Marine Bio Resources Co., Ltd., weight average molecular weight of 400000): 1% and an emulsifying agent (polyoxyethylene sorbitan monooleate, trade name “WILSURF TF-80”, manufactured by NOF CORPORATION): 1.7% were mixed and dissolved in water to prepare a comparative composition (comparative stock solution) 17.

### Preparation of Preservation Liquid

To each of the preservative compositions and comparative compositions prepared in Examples 1 to 29 and Comparative Examples 1 to 17, water was further added in an amount that made the total mass of each composition (stock solution) 10 times larger to dilute each composition (stock solution), thereby preparing preservation liquids 1 to 29 and comparative liquids 1 to 17. The content of each component in each preservation liquid is shown in upper rows in Tables 1 to 6 below.

### Evaluation of Shelf Life

Evaluation of the shelf life of fruit and vegetables were conducted using the preservation liquids 1 to 29 obtained from the preservative compositions (stock solutions) 1 to 29 prepared in Examples 1 to 29 and comparative liquids 1 to 17 obtained from the comparative compositions (comparative stock solutions) 1 to 17 prepared in Comparative Examples 1 to 17. As the fruit and vegetables, pineapples (made in the Philippines) harvested on that day were used, and each of the preservation liquids 1 to 29 and comparative liquids 1 to 17 was sprayed on almost the whole pineapple the crown of which was cut. Each preservation liquid and each comparative liquid were sprayed on the whole pineapple uniformly using a manual spray, and then air was applied to excess liquid not to cause dropping of the liquid. For each preservation liquid and each comparative liquid, 18 pineapples were used to conduct evaluation. In addition, 18 pineapples, which is other than the pineapples on which a preservation liquid or a comparative liquid was sprayed, were made to cut the crowns and used as the control for checking the improvement in the shelf life.

Each pineapple on which a preservation liquid or a comparative liquid was sprayed and pineapples as the control were stored in a thermostatic chamber at a temperature of 7° C. and at a humidity of 95% RH, and visual observations were conducted once every week up to 3 weeks to check the state of occurrence of rot, mold, and discoloration such as partial sunburn (hereinafter, referred to as “partial discoloration”). The effect of improving the shelf life was evaluated according to the following criteria.

AA . . . Occurrence of any of rot, mold, and partial discoloration was not ascertained for all of 18 pineapples.

A . . . Occurrence of any of rot, mold, and partial discoloration was not ascertained in a half or more of 18 pineapples, but occurrence of rot, mold, or partial discoloration was ascertained slightly in less than half of the 18 pineapples.

B . . . Occurrence of at least any of rot, mold, and partial discoloration was ascertained at several points in a half or more of 18 pineapples.

C . . . Occurrence of at least any of rot, mold, and partial discoloration was ascertained at many points in a half or more of 18 pineapples.

The evaluation results obtained when the preservation liquids and the comparative liquids in respective examples above were used are shown in lower rows in Tables 1 to 6.

TABLE 1
Compositions (% by mass) and evaluation results of preservation liquids

| | | Examples | | | | | | |
|---|---|---|---|---|---|---|---|---|
| | | 1 | 2 | 3 | 4 | 5 | 6 | 7 |
| Acetic acid | | 2.00 | 0.00 | 0.00 | 2.00 | 2.00 | 2.00 | 2.00 |
| Citric acid | | 0.00 | 2.00 | 0.00 | 0.00 | 0.00 | 0.00 | 0.00 |
| Lactic acid | | 0.00 | 0.00 | 2.00 | 0.00 | 0.00 | 0.00 | 0.00 |
| Glucosamine | | 0.10 | 0.20 | 0.20 | 0.00 | 0.00 | 0.00 | 0.00 |
| N-Acetyl glucosamine | | 0.00 | 0.00 | 0.00 | 0.10 | 0.00 | 0.00 | 0.00 |
| Chitin oligosaccharide | | 0.00 | 0.00 | 0.00 | 0.00 | 0.10 | 0.00 | 0.00 |
| Chitosan oligosaccharide | | 0.00 | 0.00 | 0.00 | 0.00 | 0.00 | 0.10 | 0.00 |
| Chitosan derived from cell wall | | 0.00 | 0.00 | 0.00 | 0.00 | 0.00 | 0.00 | 0.10 |
| Water | | Balance | Balance | Balance | Balance | Balance | Balance | Balance |
| Shelf life | 1 Week | AA | AA | AA | AA | AA | AA | AA |
| | 2 Weeks | AA | A | A | A | A | A | A |
| | 3 Weeks | A | B | B | A | B | B | A |

TABLE 2
Compositions (% by mass) and evaluation results of preservation liquids

| | | Examples | | | | | |
|---|---|---|---|---|---|---|---|
| | | 8 | 9 | 10 | 11 | 12 | 13 |
| Acetic acid | | 2.00 | 2.00 | 2.00 | 2.00 | 0.00 | 0.00 |
| Citric acid | | 0.00 | 0.00 | 0.00 | 0.00 | 2.00 | 0.00 |
| Lactic acid | | 0.00 | 0.00 | 0.00 | 0.00 | 0.00 | 2.00 |
| Glucosamine | | 0.10 | 0.10 | 0.10 | 0.10 | 0.10 | 0.10 |
| Emulsifying | | 0.17 | 0.17 | 0.17 | 0.17 | 0.17 | 0.17 |
| agent | | | | | | | |
| Hydroxypropyl | | 0.00 | 0.70 | 0.00 | 0.70 | 0.00 | 0.00 |
| cellulose | | | | | | | |
| Propylene | | 0.00 | 0.00 | 1.20 | 1.20 | 0.00 | 0.00 |
| glycol | | | | | | | |
| Water | | Balance | Balance | Balance | Balance | Balance | Balance |
| Shelf | 1 week | AA | AA | AA | AA | AA | AA |
| life | 2 Weeks | AA | A | A | AA | A | A |
| | 3 Weeks | B | A | B | A | B | B |

TABLE 3
Compositions (% by mass) and evaluation results of preservation liquids

| | | Examples | | | | | | | |
|---|---|---|---|---|---|---|---|---|---|
| | | 14 | 15 | 16 | 17 | 18 | 19 | 20 | 21 |
| Acetic acid | | 2.00 | 2.00 | 2.00 | 2.00 | 0.50 | 3.00 | 2.00 | 2.00 |
| Glucosamine | | 0.00 | 0.00 | 0.00 | 0.00 | 0.10 | 0.10 | 0.01 | 1.50 |
| N-Acetyl glucosamine | | 0.10 | 0.00 | 0.00 | 0.00 | 0.00 | 0.00 | 0.00 | 0.00 |
| Chitin oligosaccharide | | 0.00 | 0.10 | 0.00 | 0.00 | 0.00 | 0.00 | 0.00 | 0.00 |
| Chitosan oligosaccharide | | 0.00 | 0.00 | 0.10 | 0.00 | 0.00 | 0.00 | 0.00 | 0.00 |
| Chitosan derived from cell wall | | 0.00 | 0.00 | 0.00 | 0.10 | 0.00 | 0.00 | 0.00 | 0.00 |
| Emulsifying agent | | 0.17 | 0.17 | 0.17 | 0.17 | 0.17 | 0.17 | 0.17 | 0.17 |
| Hydroxypropyl cellulose | | 0.00 | 0.00 | 0.00 | 0.00 | 0.00 | 0.70 | 0.00 | 0.70 |
| Propylene glycol | | 0.00 | 0.00 | 0.00 | 0.00 | 0.00 | 0.00 | 1.20 | 1.20 |
| Water | | Balance | Balance | Balance | Balance | Balance | Balance | Balance | Balance |
| Shelf life | 1 Week | AA | AA | AA | AA | AA | AA | AA | AA |
| | 2 Weeks | A | A | A | A | A | A | A | AA |
| | 3 Weeks | B | B | B | B | B | A | B | A |

TABLE 4
Compositions (% by mass) and evaluation results of preservation liquids

| | | Examples | | | | | | | |
|---|---|---|---|---|---|---|---|---|---|
| | | 22 | 23 | 24 | 25 | 26 | 27 | 28 | 29 |
| Citric acid | | 0.50 | 3.00 | 2.00 | 2.00 | 0.00 | 0.00 | 0.00 | 0.00 |
| Lactic acid | | 0.00 | 0.00 | 0.00 | 0.00 | 0.50 | 3.00 | 2.00 | 2.00 |
| Glucosamine | | 0.10 | 0.10 | 0.01 | 1.50 | 0.10 | 0.10 | 0.01 | 1.50 |
| Emulsifying agent | | 0.17 | 0.17 | 0.17 | 0.17 | 0.17 | 0.17 | 0.17 | 0.17 |
| Hydroxypropyl cellulose | | 0.00 | 0.70 | 0.00 | 0.70 | 0.00 | 0.70 | 0.00 | 0.70 |
| Propylene glycol | | 0.00 | 0.00 | 1.20 | 1.20 | 0.00 | 0.00 | 1.20 | 1.20 |
| Water | | Balance | Balance | Balance | Balance | Balance | Balance | Balance | Balance |
| Shelf life | 1 Week | AA | AA | AA | AA | AA | AA | AA | AA |
| | 2 Weeks | A | A | A | AA | A | A | A | AA |
| | 3 Weeks | B | A | B | A | B | A | A | A |

TABLE 5
Compositions (% by mass) and evaluation results of comparative liquids

| | | Comparative Examples | | | | | | | | | |
|---|---|---|---|---|---|---|---|---|---|---|---|
| | | 1 | 2 | 3 | 4 | 5 | 6 | 7 | 8 | 9 | 10 |
| Acetic acid | | 2.00 | 0.00 | 0.50 | 3.00 | 0.00 | 0.00 | 0.00 | 0.00 | 0.00 | 0.00 |
| Citric acid | | 0.00 | 0.00 | 0.00 | 0.00 | 0.00 | 0.00 | 0.50 | 3.00 | 0.00 | 0.00 |
| Lactic acid | | 0.00 | 0.00 | 0.00 | 0.00 | 0.00 | 0.00 | 0.00 | 0.00 | 0.50 | 3.00 |
| Glucosamine | | 0.00 | 0.10 | 0.00 | 0.00 | 0.01 | 2.50 | 0.00 | 0.00 | 0.00 | 0.00 |
| Emulsifying agent | | 0.17 | 0.17 | 0.17 | 0.17 | 0.17 | 0.17 | 0.17 | 0.17 | 0.17 | 0.17 |
| Water | | Balance | Balance | Balance | Balance | Balance | Balance | Balance | Balance | Balance | Balance |
| Shelf life | 1 Week | B | C | B | C | C | B | C | C | C | C |
| | 2 Weeks | C | C | C | C | C | C | C | C | C | C |
| | 3 Weeks | C | C | C | C | C | C | C | C | C | C |

TABLE 6
Compositions (% by mass) and evaluation results of comparative liquids

| | | Comparative Examples | | | | | | | |
|---|---|---|---|---|---|---|---|---|---|
| | | 11 | 12 | 13 | 14 | 15 | 16 | 17 | Control |
| N-Acetyl glucosamine | | 0.01 | 0.50 | 0.00 | 0.00 | 0.00 | 0.00 | 0.00 | |
| Chitin oligosaccharide | | 0.00 | 0.00 | 0.01 | 0.10 | 0.00 | 0.00 | 0.00 | |
| Chitosan oligosaccharide | | 0.00 | 0.00 | 0.00 | 0.00 | 0.01 | 2.50 | 0.00 | |
| Chitosan | | 0.00 | 0.00 | 0.00 | 0.00 | 0.00 | 0.00 | 0.10 | |
| Emulsifying agent | | 0.17 | 0.17 | 0.17 | 0.17 | 0.17 | 0.17 | 0.17 | |
| Water | | Balance | Balance | Balance | Balance | Balance | Balance | Balance | |
| Shelf life | 1 Week | B | B | B | C | B | B | C | C |
| | 2 weeks | C | C | C | C | C | C | C | C |
| | 3 Weeks | C | C | C | C | C | C | C | C |

As it is understood from the evaluation results of Examples 1 to 29 and the control, it was confirmed that the shelf life of pineapple can be improved when the preservation liquids of Examples 1 to 29 are used. In addition, it was confirmed from the evaluation results of Examples 1 to 29 and Comparative Examples 1 to 17 that glucosamine and the like in the preservation liquid can be an active ingredient for improving the shelf life. Further, it was confirmed that the luster is brought about more on the pineapples on which the preservation liquid was sprayed in Examples 11, 21, 25, and 29 where the spreading agent and the preservative are blended than in the other examples. In addition, in any of Comparative Examples 1, 3, 4, and 7 to 10, partial discoloration was ascertained at many points, and besides, the occurrence of rot or discoloration accompanying the rot, and mold was also ascertained at several points in a half or more of the pineapples 2 weeks after the start of the test. Furthermore, in any of Comparative Examples 2, 5, 6, and 11 to 17, rot or discoloration accompanying the rot was ascertained at many points, and besides, the occurrence of mold was also ascertained at several points 2 weeks after the start of the test.

### INDUSTRIAL APPLICABILITY

The preservative composition according to the present invention is useful for improving fruit and vegetables, suitably for improving various kinds of edible fruit and vegetables.

1. A preservative composition for fruit and vegetables, the preservative composition comprising:
an organic acid and/or a salt thereof and
at least one selected from the group consisting of glucosamine, glucosamine derivatives, chitin oligosaccharides, chitosan oligosaccharides, and salts thereof.

2. The preservative composition according to claim 1, comprising glucosamine derived from a microorganism as the glucosamine.

3. The preservative composition according to claim 1, wherein the organic acid and/or the salt thereof is at least one selected from the group consisting of acetic acid, citric acid, lactic acid, and salts thereof.

4. The preservative composition according to claim 1, further comprising an emulsifying agent.

5. The preservative composition according to claim 1, further comprising a spreading agent.

6. The preservative composition according to claim 1, wherein a content of the at least one selected from the group consisting of glucosamine, glucosamine derivatives, chitin oligosaccharides, chitosan oligosaccharides, and salts thereof is 0.1 to 20% by mass.

7. The preservative composition according to claim 1, wherein a content of the organic acid and/or the salt thereof is 1 to 50% by mass.

8. A preservation liquid for fruit and vegetables, the preservation liquid comprising:
the preservative composition according to claim 1; and
a liquid medium.

9. The preservation liquid according to claim 8, wherein a content of the at least one selected from the group consisting of glucosamine, glucosamine derivatives, chitin oligosaccharides, chitosan oligosaccharides, and salts thereof is 0.01 to 5% by mass.

10. The preservation liquid according to claim 8, wherein a content of the organic acid and/or the salt thereof is 0.1 to 10% by mass.

11. Fruit and vegetables treated with the preservation liquid according to claim 8.
